(19) United States
(12) Patent Application Publication
(10) Pub. No.: US 2002/0080544 A1
(43) Pub. Date: Jun. 27, 2002

(54) Apparatus and methods for limiting electrical current in circuit breaker applications

(76) Inventor: John Pellegrino, Westford, MA (US)

Correspondence Address: Testa, Hurwitz & Thibeault, LLP, High Street Tower, 125 High Street, Boston, MA, 02110, US

(21) Appl. No.: 09/748,596

(22) Filed: Dec. 22, 2000

(51) Int. Cl. H02H 3/08

(52) U.S. Cl. 361/93.9; 327/58

(57) ABSTRACT

Apparatus and methods for limiting transient current in an electrical power system in response to an over-current condition where a current-limiting electronic circuit breaker senses electrical current flowing in a circuit and isolates the electrical power source when the current is greater than a first preset value. During the time delay from the time that the electrical current increases above a first preset value and until circuit breaker opens, where the electrical current increases above a second preset value, greater than the first, the electrical current is limited to a maximum value.

### FIELD OF THE INVENTION

The present invention relates generally to electrical power systems and specifically to limiting current in electrical device applications.

### BACKGROUND OF THE INVENTION

In electrical power systems it is highly desirable that the electrical load-side of the power circuit formed by the interconnection of a power supply to a load be both energy and current limited for all possible load conditions including reasonable fault conditions. (An electrical power system short-circuit-to-ground is an example of a reasonable fault condition.) If the electrical energy and current amplitude delivered to an electrical load are not limited, the power supplies can experience abnormal voltage disturbances, such as transients where the voltage and current amplitudes rise to arbitrarily large values for brief periods of time. Protection from electrical power disturbance is particularly important for system applications requiring high-reliability and high-availability, such as fault-tolerant computing applications serving the financial industry, emergency services, and military systems.

Fault-tolerant computing applications often provide a redundant power system, where power supplies may be interconnected in a manner referred to as “diode ORed” where a single supply voltage is maintained by one or more power supplies. If the voltage output of one of several power supplies is removed, the supplied system voltage is maintained by the redundant power supplies. Abnormal power disturbances could result in propagation of a fault conditions to other parts of a system, and even perhaps to the entire power system. This is particularly a problem for fault-tolerant topologies, where such abnormal disturbances could defeat the redundancies built into the system and result in a system failure.

Some solutions include the incorporation of an energy limiting device, such as a thermal fuse, connected in series with the electrical load. Other solutions incorporate low impedance, high current capacity electrical conductors in combination with high-energy capacitors placed locally at the loads. These capacitors are capable of providing sufficient energy to “blow” the fuse in the event of a sufficiently high current draw from the load. These solutions buffer the power supply from having to source sufficient energy in the event of a load disturbance.

Although these solutions serve the purpose of protecting the power source, there are distinct disadvantages. The high-energy capacitors and high-current conductors are larger in size, heavier, and more expensive than their low-energy counterparts. In many electronic applications, it is desirable to provide a similar level of protection without the additional expense, consumption of circuit-board real estate, and weight. Also, a thermal fuse must be physically replaced when blown. Disadvantages of the fuse relate to the prospect of additional maintenance costs associated with having to manually service the system each time a fuse is blown. Cost and down-time are particular concerns in service requirements for systems, and particularly high-availability systems, that are operated in an un-staffed, or “lights-out” type of facility.

Resettable circuit breakers are available and alleviate some of the concerns with maintenance costs and component size. Electronic circuit breakers are also available offering a greater precision in sensing abnormal load conditions. Some electronic circuit breakers sense the electrical current being supplied to a load and control a series-connected Field Effect Transistor (FET), operated as a switch, to open. Drawbacks to this approach involve a delay from the time when an over-current condition is sensed and the FET switch is actually opened. During even a short delay, current amplitudes can rise to levels sufficient to propagate faults to the power system. The present invention avoids this problem.

### SUMMARY OF THE INVENTION

The present invention relates to apparatus and methods for limiting electrical current in circuit breaker applications. One embodiment of the invention senses electrical current flowing in a circuit incorporating an electronic circuit breaker that, after a predetermined time period, isolates the electrical power source from a load impedance when the sensed electrical current is greater than a first preset value and limits the electrical current to a predetermined maximum value when the sensed electrical current is greater than a second preset value, greater than the first, thereby limiting the maximum allowable electrical current during the predetermined time period until the electronic circuit breaker isolates the electrical power source.

In one aspect, an electronic controller senses an electrical current and controls a controllable FET switch connected in series with an electrical power source and an electrical load. Operation of the FET switch controls the flow of electrical current to isolate an electrical power source from a load impedance after a predetermined time period by controlling the series-connected, controllable FET switch to open when a sensed electrical current is greater than a first preset value. A fast current-limiting circuit senses an electrical current and approximately instantaneously reduces a gate voltage of the controllable FET switch, thereby limiting the maximum electrical current flow until the controllable FET switch is opened by the electronic controller. In this embodiment, the fast current-limiting circuit is a two stage amplifier.

In another aspect, a method for isolating an electrical source from an load impedance where a series-connected, controllable FET switch is controlled by an electronic controller and a current-limiting circuit. The electronic controller and the current-limiting circuit both sense an electrical current flowing through the controllable FET switch. The electronic controller compares the sensed electrical current to a first preset value and controls the controllable FET switch to open after the sensed electrical current has surpassed and remained greater than a first preset value for a predetermined time period. The current-limiting circuit simultaneously compares the sensed electrical current to a second preset value, and reduces the gate voltage of the controllable FET switch to limit the maximum electrical current, until the controllable FET switch is controlled open by the electronic controller. In this embodiment, the second preset value is greater than the first preset value.

### BRIEF DESCRIPTION OF THE DRAWINGS

The invention is pointed out with particularity in the appended claims. The drawings are not necessarily to scale, emphasis instead generally being placed upon illustrating the principles of the invention. Like reference characters in the respective drawing figures indicate corresponding parts. The advantages of the invention described above, as well as further advantages of the invention, may be better understood by reference to the description taken in conjunction with the accompanying drawings, in which:

FIG. 1 is a block diagram of an embodiment of an electrical power system with an electronic circuit breaker including a fast-acting, current-limiting circuit;

FIG. 2 is a graphical representation of an electrical current response to an embodiment of the invention;

FIG. 3 is a graphical representation of current-voltage characteristics of a Field Effect Transistor (FET);

FIG. 4 is a block diagram of one embodiment of an electrical power system with a current-limiting circuit; and

FIG. 5 is a flowchart of the steps to be taken by one embodiment of an electronic circuit breaker including a fast-acting, current-limiting circuit.

### DETAILED DESCRIPTION OF THE INVENTION

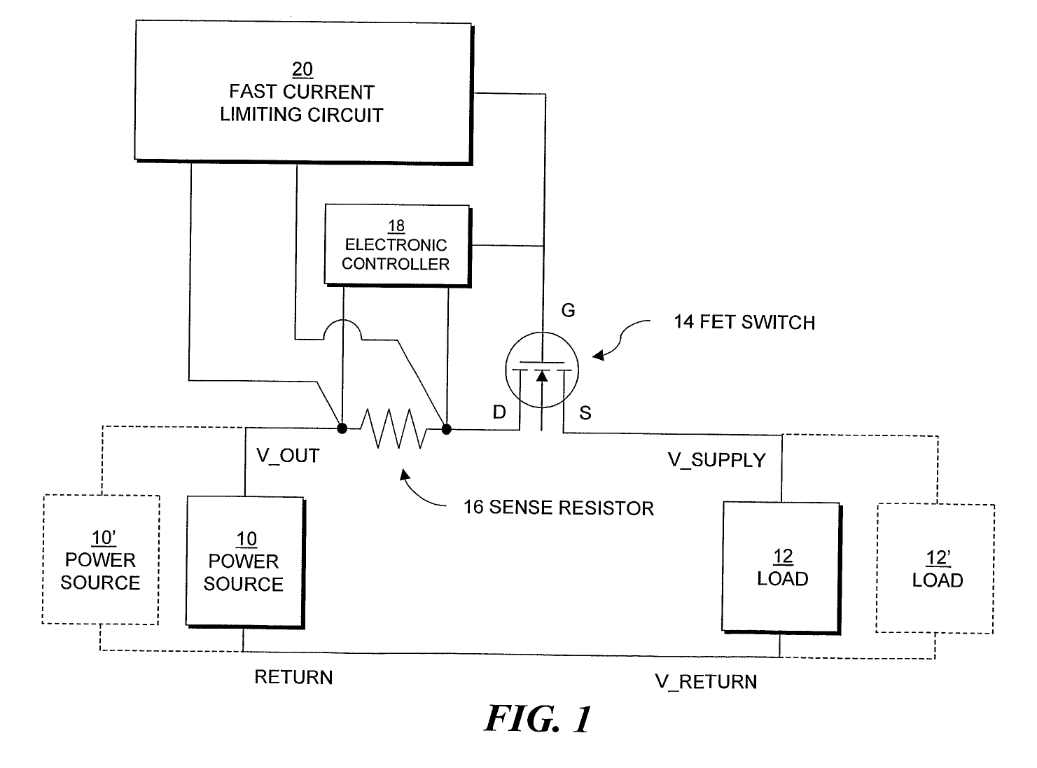

Referring to FIG. 1, one embodiment of an electrical power distribution system with an electronic circuit breaker is shown in which the present invention can be used. The system includes multiple redundant “diode-ORed” power sources 10 and 10′ (generally 10). In one embodiment, the electrical power sources 10 are Direct Current (DC) power supplies providing a positive output voltage. In another embodiment, the electrical power sources 10 are DC power supplies providing a negative output voltage. The system also includes one or more electrical loads 12, 12′ (generally 12). In one embodiment, the electrical loads 12 are circuit cards. In another embodiment, the electrical loads are system modules. In yet another embodiment, the electrical loads 12 are electrical components. The system also includes a controllable FET 14, a sensing resistive element 16, an electronic controller 18, and a fast-acting, current-limiting circuit 20. In one embodiment, the controllable FET 14 is an N-channel device.

In one embodiment, the electrical power source 10 has at least two terminals, an output voltage terminal (V_OUT) and an electrical return terminal (RETURN). The power source 10 supplies an output voltage at the V_OUT terminal with respect to the RETURN terminal. The V_OUT terminal of the power source 10 is in electrical communication with a first terminal (V_SUPPLY) of an electrical load 12 through a sensing resistive element (sense resistor) 16 and a series-connected, controllable FET 14.

The controllable FET 14 has at least three terminals: a source terminal (S); a drain terminal (D); and a gate terminal (G). In the embodiment shown in FIG. 1, a V_OUT terminal of the power source 10 is in electrical communication with a drain terminal of the controllable FET 14 and a source terminal of the controllable FET 14 is in electrical communication with a V_SUPPLY terminal of the electrical load 12. A second terminal (V_RETURN) of the electrical load 12 is in electrical communication with a RETURN terminal of the power source 10. Referring to FIG. 1, the sensing resistor 16 is shown located between the V_OUT terminal of the power source 10 and the drain terminal of the controllable FET 14; however, sensing resistor 16 can be located within any other segment of the circuit formed by the electrical leads interconnecting the power source 10 and the electrical load 12, such as between the controllable FET 14 and the electrical load 12.

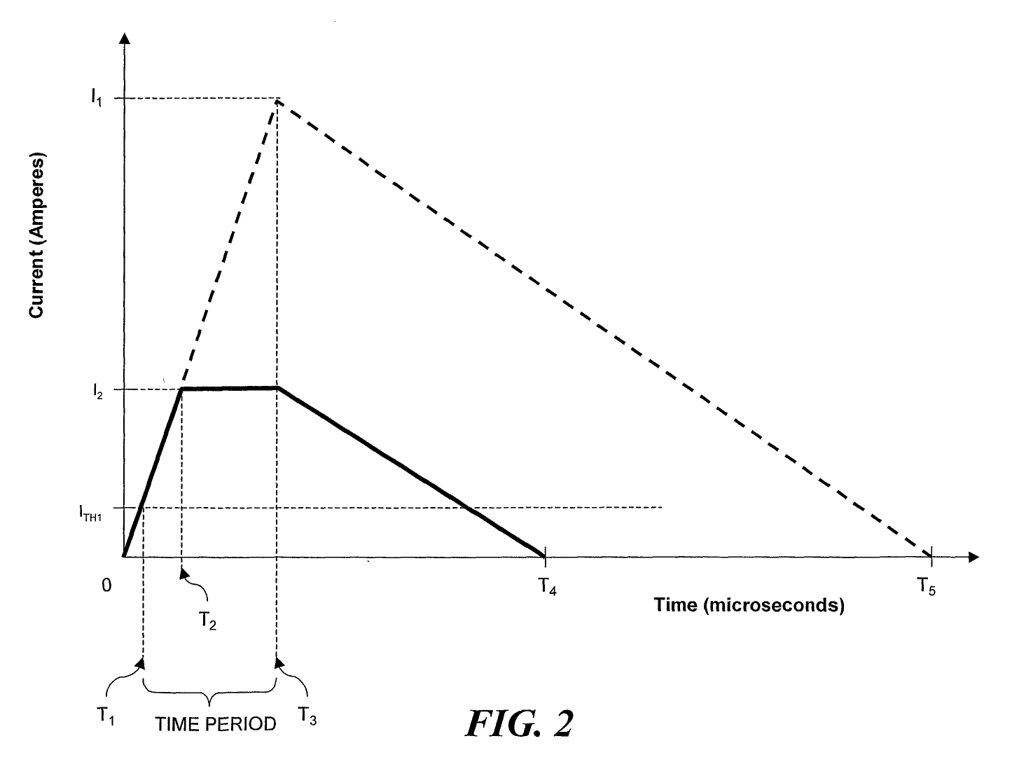

Referring to FIG. 2, a graphical representation of the electrical current amplitude versus time is shown where the vertical axis measures increasing electrical current in terms of Amperes and the horizontal axis measures increasing time in terms of microseconds. The intersection of the two axes, representing the origin of this coordinate system, represents a zero-value of electrical current and a zero-value of time. The absolute value of time is irrelevant, rather only the relative time measured from the time of an event causing the electrical current to increase in a manner shown in FIG. 2 is important. Therefore, the time value at the origin is shown as zero and represents the time of an event, such as a short-circuit-to-ground, causing the electrical current to increase.

In one embodiment, referring again to FIG. 1, an electronic controller 18, a sensing resistor 16, and a series-connected, controllable FET 14 form an electronic circuit breaker. The electronic controller 18 substantially continuously monitors an electrical current flowing within the circuit formed by the power source 10 connected to an electrical load 12. The sensing resistor 16 is series-connected, allowing the passage of all circuit electrical current supplied by the power source 10. The electronic controller 18 determines the circuit electrical current by sensing a voltage across a first and second terminal of the sensing resistor 16, where a corresponding value of electrical current is determinable by dividing the measured voltage across sensing resistor 16 by the resistive value of the sensing resistor 16. In one embodiment, the sensing resistor 16 provides a low-value resistance to minimize the power dissipated within the sensing resistor 16. In another embodiment, the resistive value of sensing resistor 16 is less than approximately one Ohm. Other embodiments are possible where the sensing resistor could be replaced by other means such as an inductive electrical current sensor, determining the electrical current level by sensing the magnetic field induced by the current.

When the electronic controller 18 senses that an electrical current has increased above a first preset value, shown in FIG. 2 as I_{TH1}, and has remained at a level above the first preset value for a predetermined time period, the electronic controller 18 provides a control signal to the gate terminal of the controllable FET 14 to open the circuit, thus inhibiting the electrical current flow.

The predetermined time period is measured from the time that the monitored electrical current first increases above the first preset value, T₁ in FIG. 2, until the time that the electronic controller 18 controls the controllable FET 14 to open, T₃ in FIG. 2, is a deliberate design feature. The predetermined time period ensures that the electronic controller 18 does not respond substantially instantaneously to an electrical current value above I_{TH1}, such as due to electrical noise that may be present on the electrical conductors of the power distribution system. Electrical transients, or fluctuations from an intended signal or power level on a particular electrical conductor may occur during normal operation of electrical circuits. Electrical transients are particularly likely on power distribution circuits where redundant circuits are “hot swapped,” or disconnected and reconnected to the power source 10 while the power source 10 continues to supply power. These electrical transients may occur at amplitudes that are substantially greater than the nominal electrical signal or power level, but the fluctuations in amplitude are typically short lived.

Intense yet brief increases in an electrical current level are less likely to cause a disturbance to a power distribution system because the total energy content is not significant enough to cause physical damage. If the electronic controller 18 responded instantaneously to any variation of the monitored electrical current above the first preset value, it would control the controllable FET 14 to open upon each occurrence of such an electrical transient. The electronic circuit breaker would then “trip” each time there was an electrical transient with an amplitude greater than the first preset value. If multiple transients occurred before an electronic circuit breaker could be reset, the entire redundant power system could be effected, causing an undesirable impact to system availability when there may in fact be no true fault condition.

Responses to electrical transients can be avoided by including a predetermined time period such that the electronic controller 18 requires a monitored electrical current to remain above a first preset value for the entire predetermined time period before the electronic controller 18 controls the controllable FET 14 to open and isolate the power supply 10 from the circuit. The electronic controller 18 only controls the controllable FET 14 where there is a true likelihood of damage—the power circuit electrical current has remained above a first preset value for a period of time sufficient to provide an indication that damage could result if action were not taken. With the predetermined time period, the electronic controller 18 avoids responding to brief excursions of the power or signal level above the first preset value. In one embodiment the electronic controller is a device number LTC 1421, HOT SWAP controller, manufactured by LINEAR TECHNOLOGY CORPORATION of Milpitas, Calif.

In further detail, in one embodiment, the controllable FET 14 is operated as a switch having a first, or normal, operational mode maintaining a low impedance between the drain and source terminals allowing electrical current flow between the drain and source terminals and allowing electrical current flow between the drain and source terminals. The controllable FET 14, upon receiving an appropriate control signal at the gate terminal, such as a voltage, transitions to a second operational mode maintaining a high impedance between the drain and source terminals, thus inhibiting electrical current flow between the drain and source terminals.

Referring again to FIG. 2, from the time that the sensed electrical current amplitude is greater than a first preset value, shown as T₁, the electronic controller 18 continues to monitor the electrical current for a predetermined time period. If the electrical current remains above the first preset value for the entire predetermined time period, then the electronic controller 18 provides a controlling signal to the controllable FET 14 at time value T₃. This predetermined time period is measured as the difference in time between these two events, expressed as (T₃−T₁). Depending on the circuit condition that caused the electrical current amplitude to increase beyond a first preset value, the electrical current may continue to increase until the electronic controller 18 operates the controllable FET 14 to inhibit further electrical current flow at time T₃. In particular, where the circuit fault represents a short-circuit-to-ground, or electrical connection of any portion of the electrical circuit segment between the power source 10 voltage output terminal and the first terminal of the electrical load 12 to an electrical ground reference, or to the power source 10 return voltage terminal, the electrical current value will rise at a rate, represented by the slope of the current-versus-time curve. Thus, the circuit electrical current amplitude increases to a first maximum value, I₁, before the controllable FET 14 is controlled open at time T₃, thus inhibiting electrical current flow. For prior art solutions using an electronic controller 18 to control a controllable FET 14 switch, the electrical current amplitude variation with time is represented by the dashed curve on FIG. 2, where the electrical current amplitude attains a maximum value shown as I₁.

Referring again to FIG. 1, a fast-acting, current-limiting circuit 20 also monitors the electrical current flowing in the circuit. In one embodiment, the current-limiting circuit 20 is connected in shunt fashion to the electronic controller 18, across sensing resistor 16. The current-limiting circuit 20 determines the electrical current amplitude flowing within the circuit in a manner similar to that used by the electronic controller 18, by sensing the voltage across the first and second terminals of sensing resistor 16. In this embodiment, the current-limiting circuit 20 also provides a control signal to the controllable FET 14. The current-limiting circuit 20 does not operate the controllable FET 14 to “open”, or to substantially curtail electrical current flow between the controllable FET's 14 drain and source terminals, but rather limits the maximum electrical current flow to a second maximum value I₂.

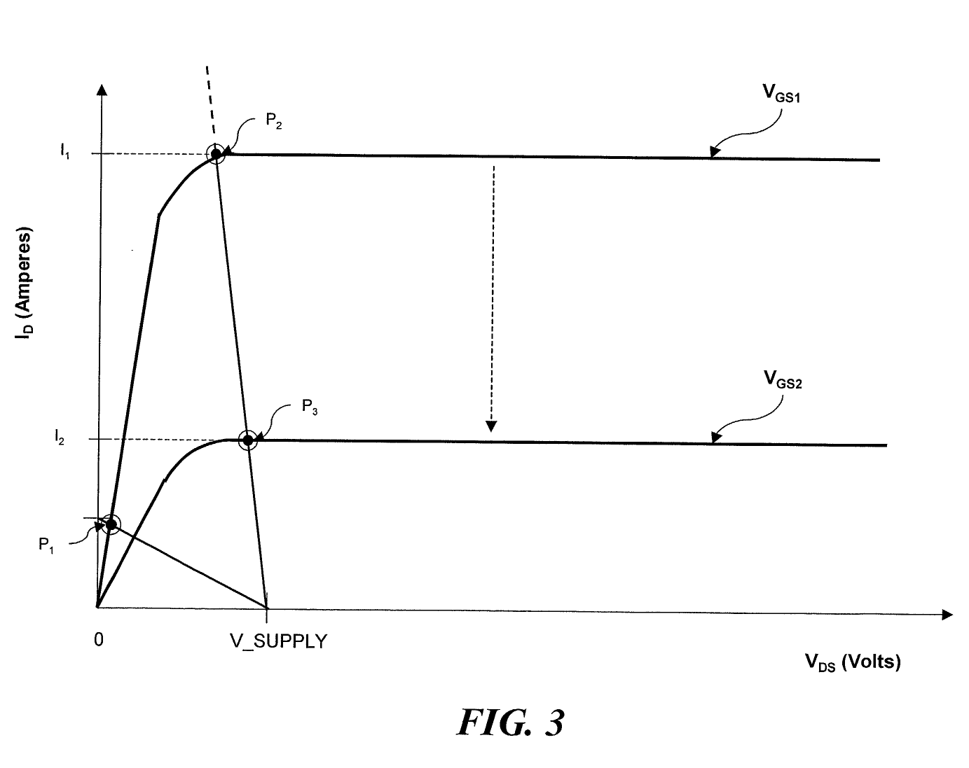

In further detail, referring to FIG. 3, the general volt-ampere characteristics of a controllable FET 14 device are shown. The vertical axis represents increasing electrical current flowing at the drain terminal, shown as I_{D} and measured in Amperes, and the horizontal axis represents increasing drain-to-source voltage, shown as V_{DS} and measured in volts. A value of gate-to-source voltage determines a particular volt-ampere characteristic curve. In one embodiment, a first gate-to-source voltage, V_{GS1}, results in an volt-ampere curve shown by the top curve of FIG. 3. Also shown in FIG. 3 is point P₁, representing a normal operating electrical current level within the power distribution circuit. P₁ is determined by the intersection of a first curve representing what is referred to by those skilled in the art as a “load line” and the characteristic volt-ampere curve of the particular controllable FET 14 biased at V_{GS1}. The load line is determined as the straight line drawn between two points: a first point on the horizontal, voltage axis representing the open circuit power supply 10 voltage level (V_SUPPLY); and a second point on the vertical, electrical current axis representing the electrical current that would flow within the power distribution circuit if the drain and source terminals of the controllable FET 14 were short circuited. The short-circuit electrical current is essentially determined as the quotient of V_SUPPLY divided by the load 12 impedance.

A second load line is also shown on FIG. 3 representing a high-current fault condition. Here, the second load line intersects the horizontal, voltage axis at the same point as the first load line, V_SUPPLY. However, the second end point of the load line along the vertical, electrical current axis occurs at an arbitrarily large electrical current value, as the situation of a short circuit to ground. Therefore, the load line's second point does not appear on FIG. 3, rather a dashed line is shown extending upward above the V_{GS1} curve. Under the same controllable FET 14 bias conditions, the circuit electrical current would be determined by the intersection of the load line with the V_{GS1} curve, shown as P₂.

In one embodiment, the current-limiting circuit 20 acts to reduce the controllable FET 14 gate voltage, causing a reduction in the controllable FET 14 gate-to-source voltage value to a new, lower value, V_{GS2}. A reduction in gate-to-source voltage, in turn, causes the controllable FET 14 to operate at a lower maximum electrical current value. The result is shown as the transition from the top volt-ampere curve V_{GS1}, having a maximum electrical current value of I₁, to the bottom volt-ampere curve V_{GS2} having a lower maximum electrical current value of I₂. The resulting operating electrical current level is represented by the intersection of the second (high-current fault condition) load line and the V_{GS2} bias curve, represented by P₃.

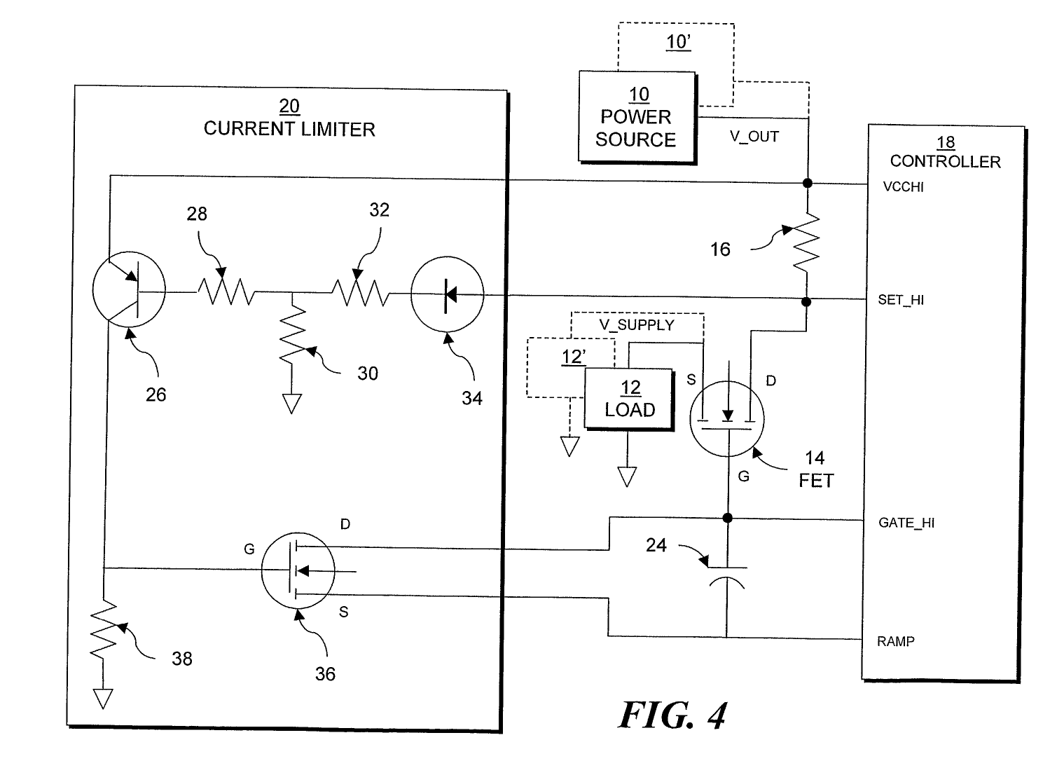

Referring to FIG. 4, in one embodiment, the current limiter 20 further comprises a transistor 26, a diode 34, a FET 36, and resistive elements 28, 30, 32, and 38. In one embodiment, the transistor 26 is PNP-type bipolar junction transistor, known to those skilled in the art, where an emitter terminal is in electrical communication with the first side of resistive element 16, and in further electrical communication with a VCCHI terminal of the electronic controller 18 and with a V_OUT terminal of the power source 10. A collector terminal of the transistor 26 is in electrical communication with a first side of a resistive element 38 and with a gate terminal of the FET 36. A second side of the resistive element 38 is in electrical communication with an electrical ground potential. The electrical ground potential is also in electrical communication with the RETURN terminal and the V_RETURN terminal.

A base terminal of the transistor 26 is in electrical communication with a first side of resistive a element 28 and a second side of resistive the resistive element 28 is in electrical communication with a first side of resistive elements 30 and 32. A second side of the resistive element 30 is in electrical communication with an electrical ground potential and a second side of the resistive element 32 is in electrical communication with a cathode terminal of the diode 34. An anode terminal of the diode 34 is in electrical communication with a second side of sensing resistor 16, and in further electrical communication with a SET_HI terminal of the electronic controller 18 and with a drain terminal of the controllable FET 14. In one embodiment, the diode 34 is a schottky diode. A source terminal of the controllable FET 14 is in electrical communication with a first terminal of the electrical load 12 and a second terminal of the electrical load 12 is in electrical communication with an electrical ground potential.

A drain terminal of the FET 36 is in electrical communication with a gate terminal of the controllable FET 14, a first side of a capacitor 24 and a GATE_HI terminal of the electronic controller 18. A source terminal of the FET 36 is in electrical communication with a second side of the capacitor 24 and with a RAMP terminal of the electronic controller 18.

A resistive network formed by resistive elements 28, 30, and 32 in combination with a diode 34, and a voltage supplied by the V_OUT terminal of the power source 10, self-bias the transistor 26 in a particular operating region. The diode 34, in combination with the transistor 26 self-biasing resistive network, determines a threshold sensing value of electrical current flowing through the sensing resistor 16, referred to as the second threshold value. The second threshold value is selected to be greater than the first preset value of the electronic controller 18. In one embodiment, the second threshold value is approximately four times a first threshold value, where the first threshold value is determined by the electronic controller 18.

Under normal operating conditions, a nominal electrical current flows within the circuit formed by the power source 10 and the electronic loads 12, causing a sensing voltage, determined as a voltage drop across the sensing resistor 16. The sensing voltage is determined from the product of the electrical current with the resistive value of sensing resistor 16. Under normal operation, the sensing voltage is below both the first and the second threshold values. Where the sensing voltage is below a second threshold value, the diode 34 is forward biased, allowing an electrical current to flow into the self-biasing resistive network. The transistor 26 is operated in a “cut-off” mode such that the electrical current flowing into the collector terminal of the transistor 26 is approximately equal to the electrical current flowing into the base terminal of the transistor 26. The base current is a small value, typically much less than 1 micro-ampere. In the cut-off mode of operation, the voltage at the gate terminal of the FET 36 is determined by the product of the transistor 26 collector current and the resistance value of the resistive element 38. Where the collector current is small, the gate voltage of the FET 36 is low. A low value of gate voltage for an N-channel FET results in a relatively low value of drain current. In one embodiment, the FET 36 functions as an open switch in response to a near-zero gate voltage. With the FET 36 acting as an open switch, the capacitor 24 maintains a stored charge value. In one embodiment, the stored charge of the capacitor 24 and the output voltage from the GATE_HI terminal of the electronic controller 18 maintain a sufficiently large gate voltage to control the series-connected, controllable FET 14 in a closed switch position. Thus, having a relatively large, non-zero gate voltage, the controllable FET 14 behaves as a closed switch and allows an electrical current to flow, largely unimpeded, between the drain and source terminals and from the power source 10 to the electrical loads 12.

In an operational scenario where a substantial electrical current is drawn from the power source 10, flowing within the circuit formed by the power source 10 and the electronic loads 12, the controllable FET 14 switch is controlled open. In one embodiment, a high-current condition is caused by a fault, such as a short-circuit-to-ground of the power source 10 V_OUT terminal. With a large electrical current, a sensing voltage across sensing resistor 16 is relatively high. For a short-circuit-to-ground scenario, a sensing voltage is above the first and the second preset values. Where the sensing voltage is above a second preset value, the voltage at the junction of the biasing resistors 28, 30, and 32 is reduced relative to the voltage at the emitter of transistor 26. The reduction of voltage at the resistive biasing network alters the bias condition of the transistor 26, causing the transistor 26 to operate in a “saturation” mode. In saturation mode, the electrical current flowing in the collector terminal of the transistor 26 is approximately equal to the electrical current flowing into the emitter terminal of the transistor 26. In one embodiment, the collector current is determinable by applying a technique known to those skilled in the art as Kirchoff's voltage law, where the sum of the voltages for each element within the electrical circuit loop formed by the power source 10, the emitter-to-collector saturation voltage of transistor 26, and resistive element 38 is equated to zero. In the saturation mode of operation, the voltage at the gate terminal of the FET 36 is determined by the product of the collector current and the resistive value 38. In one embodiment, where the transistor 26 is in saturation mode, the collector current is substantial, such that the gate voltage of the FET 36 approaches the supply voltage level of power source 10. A high value of gate voltage for an N-channel FET results in a relatively high value of drain current, such that the FET 36 approximates a closed switch. With FET 36 acting as a closed switch, capacitor 24 is short circuited resulting in a rapid reduction of the its stored charge value, further resulting in a rapid reduction of the gate voltage for the controllable FET 14. Having a lower gate voltage, the controllable FET 14 limits the maximum electrical current flow. Referring to FIG. 3, the controllable FET 14 gate voltage is lowered from V_{GS1} to V_{GS2}, limiting the maximum electrical current to I₂, where I₂ is set at a value greater than the first preset value I_{TH1}. The circuit transitions from operating point P₁ to operating point P₃. The maximum electrical current is held at the electrical current limit I₂ for the predetermined time period imposed by the electronic controller 18. If the electrical current remains at an approximate level I₂, which is above the first preset value, the result is that the electrical current remains at a value above the first preset value for the predetermined time period, and the electronic controller 18 controls the controllable FET 14 to an open circuit. Referring to FIG. 2, the overall result of the combined effects of the current limiter 20 and the electronic controller 18 operating during a high-current fault condition is approximated by the solid curve.

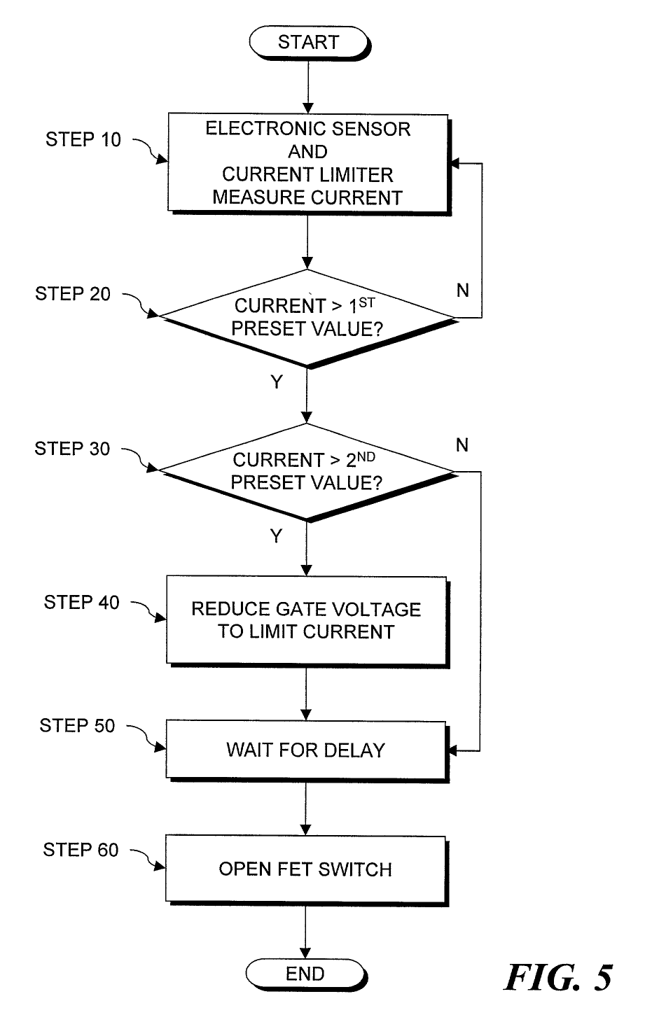

An embodiment of the fast electrical-current limiter in an electronic circuit breaker application is shown in FIG. 5. After system power-up, the power source 10 provides input power to electrical loads 12. The electronic controller 18 and the current limiter 20 simultaneously and substantially continuously measure the electrical current flowing from the power source 10 to the electrical loads 12 (step 10). In one embodiment, the electronic controller 18 and the current limiter 20 measure electrical current by sensing a voltage drop across a sensing resistor 16. The measured electrical current can be determined by using Ohm's law, whereby the measured voltage drop across the resistive element 16 is divided by the known resistance value of resistive element 16. The electronic controller 18 substantially continuously compares the measured electrical current determined in step 10 to a first preset value, representing a first predetermined threshold, until the value of electrical current has surpassed the first preset value (step 20). The current limiter 20 substantially continuously compares the measured electrical current determined in step 10 to a second preset value, representing a second predetermined threshold, where the second threshold is greater than the first threshold, until the measured electrical current value has surpassed the second preset value (step 30). Where the measured electrical current value has surpassed the second preset value, the current limiter 20 substantially simultaneously provides an output that discharges the gate voltage of the controllable FET 14, thereby limiting the maximum allowable electrical current flowing from the power source 10 to the electrical loads 12 to a value that is greater than the first preset value (step 40). Substantially simultaneously with the operation of the current limiter 20, and after the electrical current sensed by the electronic controller 18 has surpassed the first threshold, the electronic controller 18 continues to monitor the electrical current during a predetermined time period (step 50). If the level of the monitored electrical current has maintained a value greater than the first preset value throughout the predetermined time period initiated after the measured electrical current first surpassed the first threshold value, the electronic controller 18 controls the controllable FET 14 to open, effectively open-circuiting the power source 10 from the electrical loads 12 by restricting the electrical current flow between the drain and source terminals of the controllable FET 14 (step 60).

Having showed the preferred embodiments, one skilled in the art will realize that many variations are possible within the scope and spirit of the claimed invention. It is therefor the intention to limit the invention only by the scope of the claims.

What is claimed is:

1. A circuit breaker apparatus comprising:
a controllable Field Effect Transistor (FET) switch connected in series with an electrical power source and a load impedance;
an electronic controller sensing a current value and initiating an opening of the controllable FET switch by controlling a gate voltage of the controllable FET switch in response to the current value greater than a first preset value; and
a current-limiting circuit connected in parallel with the electronic controller, the current limiting circuit sensing the current value and limiting a current transient value by controlling the gate voltage of the controllable FET switch in response to the current value greater than a second preset value.

2. The apparatus of claim 1 wherein the current-limiting circuit further comprises an amplifier having a first stage and a second stage.

3. The apparatus of claim 2 wherein the first stage of the amplifier further comprises a high-side differential transistor amplifier.

4. The apparatus of claim 3 wherein the high side differential transistor amplifier further comprises a self-biased transistor.

5. The apparatus of claim 2 wherein the second stage of the amplifier further comprises a transimpedance amplifier having an output current capability for controlling the gate voltage of the controllable FET switch at least order-of-magnitude greater than the output current capability of the electronic controller.

6. The apparatus of claim 5 wherein the output current capability is at least 1 Ampere.

7. The apparatus of claim 5 wherein the transimpedance amplifier comprises a N-channel FET.

8. The apparatus of claim 1 further comprising a sensing resistor connected in series with the electrical power source and the load impedance to provide a sense voltage proportional to a current.

9. The apparatus of claim 1 wherein the electronic controller monitors the sense voltage and in response controls the gate voltage of the controllable FET switch to effect operation of the controllable FET switch.

10. The apparatus of claim 8 wherein the electronic controller operates the controllable FET switch to isolate the electrical power source from the load impedance in response to the sense voltage greater than the first preset value.

11. The apparatus of claim 8 wherein the current-limiting circuit operates to discharge the gate voltage of the controllable FET switch in response to the sense voltage above a second preset value greater than the first preset value.

12. The apparatus of claim 1 wherein the second preset value is at least four times the first preset value.

13. A method for isolating an electrical power source from a load impedance comprising:
(a) providing a controllable Field Effect Transistor (FET) switch connected in series with an electrical power source and a load impedance;
(b) providing an electronic controller in electrical communication with the controllable FET switch;
(c) providing a current limiting circuit in electrical communication with the controllable FET switch;
(d) sensing, by the electronic controller and the current limiting circuit, a current through the controllable FET switch;
(e) comparing, by the electronic controller, the current to a first preset value;
(f) prompting the electronic controller wherein the electronic controller opening, by the electronic controller, the controllable FET switch after the current has remained greater than the first preset value for a predetermined time period;
(g) comparing, by the current limiting circuit, the current to a second preset value substantially simultaneously with the electronic controller; and
(h) controlling, by the current limiting circuit, the gate voltage of the controllable FET switch when the current is greater than the second preset value.

14. The method of claim 13 wherein the second preset value is greater than the first preset value.

15. The method of claim 13 wherein the second preset value is at least four times the first preset value.

16. The method of claim 13 wherein step (f) comprises prompting the electronic controller wherein the electronic controller opening after a predetermined time period, by the electronic controller, the controllable FET switch when the current is greater than the first preset value.

17. The method of claim 13 wherein step (h) comprises controlling, by the current limiting circuit, the gate voltage of the controllable FET switch when the current is greater than the second preset value, the operation of the current limiting circuit occurring after a time delay.

18. The method of claim 17 wherein the time delay is less than the predetermined time period.

19. The method of claim 18 wherein the time delay less than 1% the predetermined time period.
